(19) United States
(12) Patent Application Publication
(10) Pub. No.: US 2010/0161737 A1
(43) Pub. Date: Jun. 24, 2010

(54) TECHNIQUES TO MANAGE ELECTRONIC MAIL PERSONAL ARCHIVES

(75) Inventors: Ashish Consul, Redmond, WA (US); Yogesh Bansal, Sammamish, WA (US); Karim M. Batthish, Seattle, WA (US); Harvey Rook, Redmond, WA (US); Lauren B. Lavoie, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/342,862

(22) Filed: Dec. 23, 2008

(51) Int. Cl. G06F 12/16; G06F 15/16; G06F 17/30

(52) U.S. Cl. 709/206; 707/E17.008; 707/E17.032

(57) ABSTRACT

Techniques to manage email personal archives are described. A computer-implemented system may comprise a primary mailbox component, associated with a user, and operative to receive and send email. The computer-implemented system may further comprise an alternate mailbox component separate from the primary mailbox component and associated with the user and the primary mailbox, operative to store email. The computer-implemented system may also include a mail client operative on a client computer to access and display contents of the primary and alternate mailboxes substantially simultaneously. Other embodiments are described and claimed.

### BACKGROUND

Electronic mail (email) is an important mode of business communication and increasingly becoming an important information source for litigation. Thus, the need to retain email while managing storage capacity is important for the individual and the company. A burden placed on any company doing business using email is the ability to retrieve the email later. However, the growth of email mailboxes may cause some organizations to limit mailbox sizes, which may cause the users to create personal archives that may be locally stored or otherwise no longer coupled to the email system. These disconnected archives may make email retrieval practically impossible. Further, companies may also not be able to monitor compliance with document retention policies.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to communications applications, such as messaging applications. Some embodiments may be particularly directed to techniques to manage email personal archives. In one embodiment, for example, a computer-implemented system may comprise a primary mailbox component, associated with a user, and operative to receive and send email. The computer-implemented system may further comprise an alternate mailbox component separate from the primary mailbox component and associated with the user and the primary mailbox, operative to store email. The computer-implemented system may also include a mail client operative on a client computer to access and display contents of the primary and alternate mailboxes substantially simultaneously. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a computer-implemented system.

FIG. 2 illustrates an embodiment of a client-server environment.

FIG. 3 illustrates an embodiment of a view.

FIG. 4 illustrates an embodiment of a logic diagram.

FIG. 5 illustrates an embodiment of a computing system.

FIG. 6 illustrates an embodiment of a computing environment.

### DETAILED DESCRIPTION

Various embodiments include physical or logical structures arranged to perform certain operations, functions or services. The structures may comprise physical structures, logical structures or a combination of both. The physical or logical structures are implemented using hardware elements, software elements, or a combination of both. Descriptions of embodiments with reference to particular hardware or software elements, however, are meant as examples and not limitations. Decisions to use hardware or software elements to actually practice an embodiment depends on a number of external factors, such as desired computational rate, power levels, heat tolerances, processing cycle budget, input data rates, output data rates, memory resources, data bus speeds, and other design or performance constraints. Furthermore, the physical or logical structures may have corresponding physical or logical connections to communicate information between the structures in the form of electronic signals or messages. The connections may comprise wired and/or wireless connections as appropriate for the information or particular structure. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Various embodiments are generally directed to techniques for managing user's email archives in a messaging application. Embodiments may provide one or more additional alternate mailboxes in addition to the conventional single primary mailbox provided by electronic mail messaging systems. The alternate mailboxes may be provided instead of allowing a user to store messages to a local device where the messages may be unavailable to an administrator of the email system. The alternate mailboxes may be separate from, and linked to, the primary mailbox. The alternate mailboxes may have reduced functionality as compared to the primary mailbox. For example, an alternate mailbox may not receive messages directly. The alternate mailboxes may be stored remotely from the mail client's host computer, and may additionally be stored separately from the primary mailbox.

Some embodiments are particularly directed to novel techniques for allowing users to store messages and other mail client data outside of their primary mailboxes, reducing primary mailbox sizes, while still retaining accessibility for the data. Various user interface views may allow users to view the contents of their alternate folder(s), and to use and manipulate the contents in a seamless and familiar manner that enhances a work flow for the user. As a result, the embodiments can improve affordability, scalability, modularity, extendibility, or interoperability for an operator, device or network.

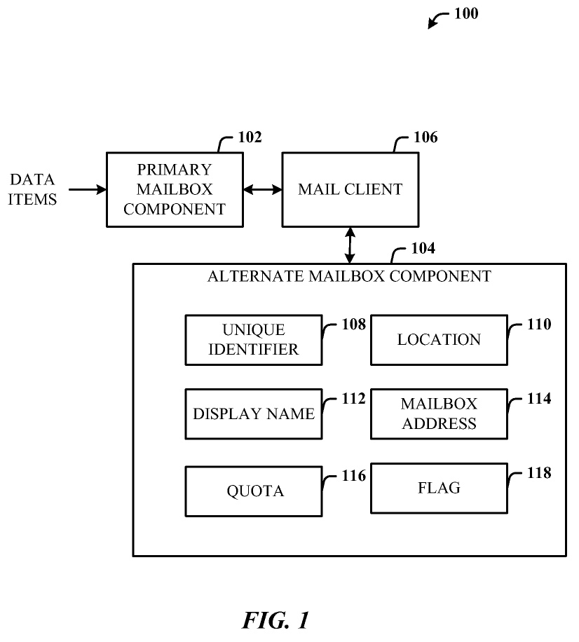

FIG. 1 illustrates a computer-implemented system 100 for managing mail system data. The system 100 includes a primary mailbox component 102 for receiving and sending mail and other data items. Other data items may include, for example, calendar appointments, tasks, reminders, etc. Primary mailbox component 102 may contain subfolders, including, for example, an inbox, a sent items folder, a deleted items folder, a search folder, and user-created folders. Primary mailbox component 102 may correspond to a specific email address for a user, and may receive email messages sent to the user's email address.

The system 100 also includes an alternate mailbox component 104 for storing mail and other data items. Alternate mailbox component 104 may be associated with a primary mailbox component 102, and with the user of primary mailbox component 102. Alternate mailbox component 104 may be provisioned by a network or mail system administrator. Alternate mailbox component 104 may also include subfolders, including, for example, a deleted items folder, a search folder, and user-created folders. In an embodiment, alternate mailbox component 104 may not have an inbox or a sent items folder. Alternate mailbox component 104 may allow a user to reply to a message stored in alternate mailbox component 104. Such a reply message may appear to come from the associated primary mailbox component 102, and a copy of the reply message may be stored in the sent items folder of the associated primary mailbox component 102. In an embodiment, deleting an item from alternate mailbox component 104 may place the deleted item in the deleted items folder of the alternate mailbox component 104.

Alternate mailbox component 104 may include a number of attributes. Attributes may include a unique identifier 108, for example, a unique graphical user interface ID (GUID). The attributes may further include an identifier for the database where the mailbox resides, a display name 112) and a mailbox address 114 associated with the alternate mailbox. Mailbox address 114 may be, for example, a SMTP address. An alternate mailbox component 104 may have a quota 116 associated with it, and/or one or more flags 118 to modify mailbox behavior. A flag may specify that an alternate mailbox may be an archive or a mirror, for example.

The system 100 may include a mail client 106, operative on a client computer, to access and display the contents of primary mailbox component 102 and alternate mailbox component 104. Mail client 106 may provide a user with the ability to view the contents of a mailbox, move a message to another mailbox, organize the contents of a mailbox, delete items from a mailbox, etc. Mail client 106 may retrieve mailbox contents and related data from a mail system server (not shown), which may be operative on one or more computers separate from the client computer. When mail client 106 connects to the mail system server, mail client 106 may automatically discover newly provisioned alternate mailboxes for the user. Mail client 106 may provide a unified view of primary mailbox component 102 and all associate alternate mailbox components of mail client 106. The unified view may allow the user to navigate seamlessly from one mailbox to another. Mail client 106 may further mail permit a user to search the primary and alternate mailboxes in the same search operation.

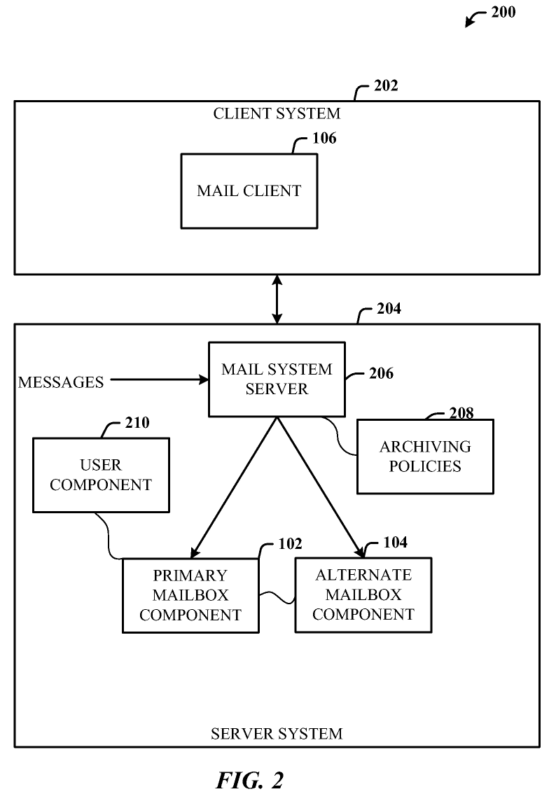

FIG. 2 illustrates a system 200 for managing mail system data using alternate mailboxes in a client-server environment. Here, mail client 106 resides on a client computer system 202. The primary mailbox component 102 and alternate mailbox component 104 may reside on a server system 204.

Server system 204 may further include a mail system server 206. Mail system server 206 may receive and route incoming email messages, and maintain the mailboxes associated with a user. Server system 204 may further include archiving policies 208 that, when applied, cause contents of the primary mailbox to be copied to, moved to, or deleted from the alternate mailbox automatically. For example, an administrator may create an archiving policy that all messages that are more than 90 days old in a user's primary mailbox are moved to the alternate mailbox on the first of each month. System server 204 may further include a user component 210 that may include a list of mailboxes associated with the user.

In an embodiment, an alternate mailbox may be disassociated with a user and associated with a new user. This may permit, for example, a new employee to “inherit” the message archive of another employee, and allow the organization to retain institutional knowledge.

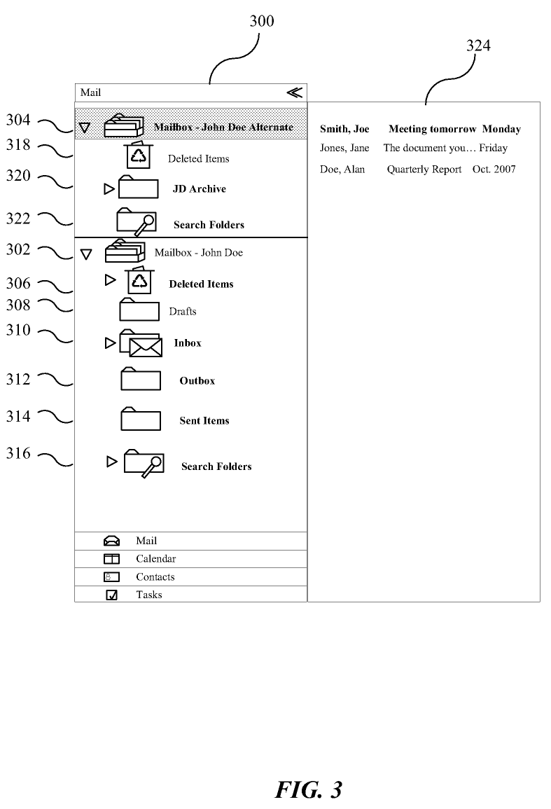

FIG. 3 illustrates a diagram for a unified view 300. The unified view 300 provides an exemplary view of various mailboxes and folders that a mail client may display, e.g. mail client 106. The mailboxes may include primary mailbox 302, and alternate mailbox 304. Primary mailbox 302 may include folders, such as deleted items 306, drafts 308, inbox 310, outbox 312, sent items 314 and search folders 316. Alternate mailbox 304 may include deleted items 318, a user-created folder 320, and search folders 322. Selecting a folder displayed in unified view 300, e.g. alternate mailbox 304, may open or update an expanded view 324 of the contents of the selected folder. Subsequently selecting another folder, including one in a different mailbox, may display the contents of the subsequently selected folder in the expanded view 324.

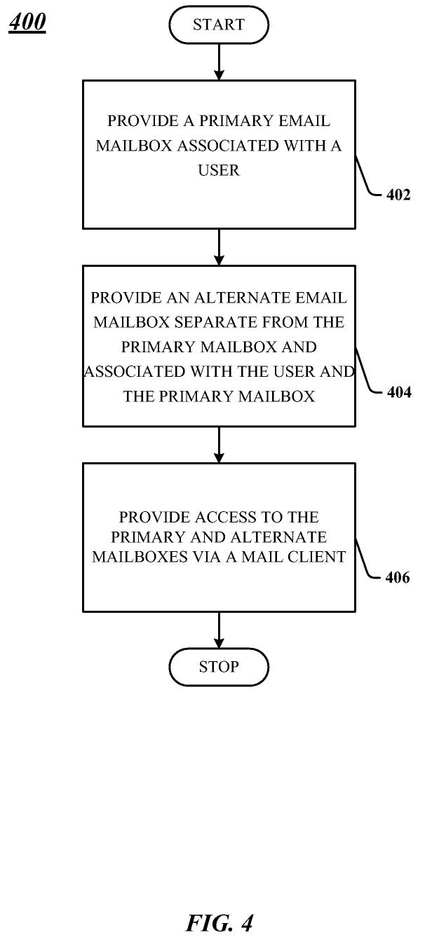

FIG. 4 illustrates one embodiment of a logic flow 400. The logic flow 400 may be representative of some or all of the operations executed by one or more embodiments described herein. For example, the logic flow 400 may illustrate a technique for managing an email personal archive.

In the illustrated embodiment shown in FIG. 4, the logic flow 400 may provide a primary email mailbox associated with a user at block 402. For example, mail system server 206 may automatically create a primary mailbox when a user is added.

The logic flow 400 may provide an alternate email mailbox at block 404. The alternate mailbox may be separate from the primary mailbox, and may be associated with the primary mailbox and with the user of the primary mailbox. The mail system server may automatically provision an alternate mailbox for a user, or may allow an administrator to provision the alternate mailbox. Providing the alternate mailbox may include storing the contents of the alternate mailbox remotely from the client computer, and/or storing the content of the alternate mailbox remotely from content of the primary mailbox. Providing the alternate mailbox may include creating and associating the alternate mailbox with the primary mailbox remotely from the client computer, and automatically discovering an alternate mailbox with the mail client, for example, when the user logs in to his or her primary mailbox.

The logic flow 400 may provide access to the primary and alternate mailboxes via a mail client at block 406. Providing access may include providing a GUI that displays the contents of the primary and alternate mailboxes, for example, as described with respect to FIG. 3. Providing access may include allowing a user to send an email as a reply to an item in the alternate mailbox, and storing a copy of the sent email in a subfolder of the primary mailbox, e.g. the sent items folder.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

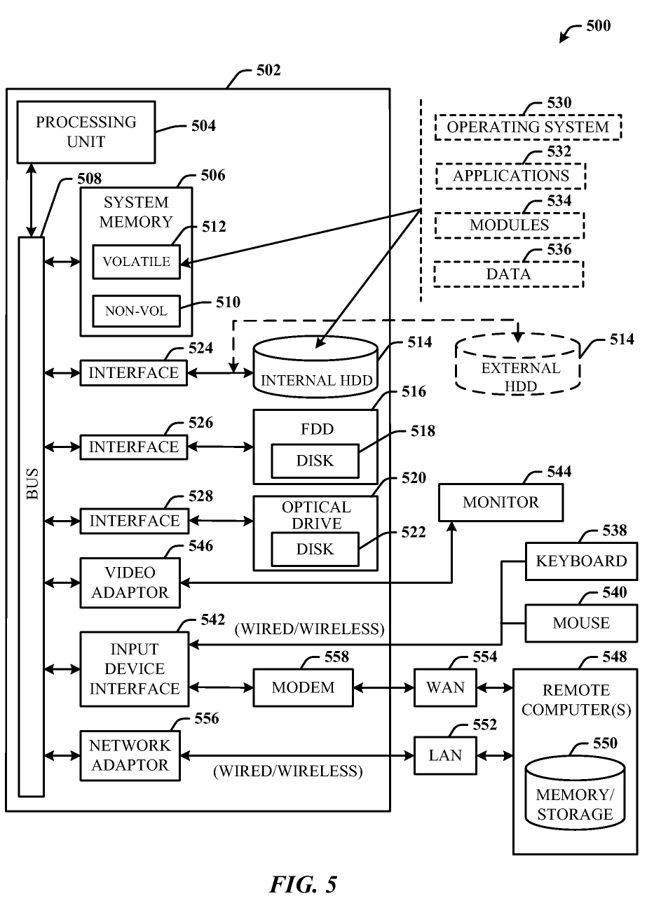

Referring now to FIG. 5, there is illustrated a block diagram of a computing system 500 operable to execute archiving for data items in accordance with the disclosed architecture. In order to provide additional context for various aspects thereof, FIG. 5 and the following discussion are intended to provide a brief, general description of a suitable computing system 500 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 5, the exemplary computing system 500 for implementing various aspects includes a computer 502 having a processing unit 504, a system memory 506 and a system bus 508. The system bus 508 provides an interface for system components including, but not limited to, the system memory 506 to the processing unit 504. The processing unit 504 can be any of various commercially available processors. Dual microprocessors and other multi-processor architectures may also be employed as the processing unit 504.

The system bus 508 can be any of several types of bus structure that may further interconnect to a memory bus (with or without a memory controller), a peripheral bus, and a local bus using any of a variety of commercially available bus architectures. The system memory 506 can include non-volatile memory (NON-VOL) 510 and/or volatile memory 512 (e.g., random access memory (RAM)). A basic input/output system (BIOS) can be stored in the non-volatile memory 510 (e.g., ROM, EPROM, EEPROM, etc.), which BIOS stores the basic routines that help to transfer information between elements within the computer 502, such as during start-up. The volatile memory 512 can also include a high-speed RAM such as static RAM for caching data.

The computer 502 further includes an internal hard disk drive (HDD) 514 (e.g., EIDE, SATA), which internal HDD 514 may also be configured for external use in a suitable chassis, a magnetic floppy disk drive (FDD) 516, (e.g., to read from or write to a removable diskette 518) and an optical disk drive 520, (e.g., reading a CD-ROM disk 522 or, to read from or write to other high capacity optical media such as a DVD). The HDD 514, FDD 516 and optical disk drive 520 can be connected to the system bus 508 by a HDD interface 524, an FDD interface 526 and an optical drive interface 528, respectively. The HDD interface 524 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 502, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 512, including an operating system 530, one or more application programs 532, other program modules 534, and program data 536. The one or more application programs 532, other program modules 534, and program data 536 can include the primary mailbox component 102, mail client 106, alternate mailbox component 104 (for client-based embodiment), and client system 202, for example.

All or portions of the operating system, applications, modules, and/or data can also be cached in the volatile memory 512. It is to be appreciated that the disclosed architecture can be implemented with various commercially available operating systems or combinations of operating systems.

A user can enter commands and information into the computer 502 through one or more wire/wireless input devices, for example, a keyboard 538 and a pointing device, such as a mouse 540. Other input devices (not shown) may include a microphone, an IR remote control, a joystick, a game pad, a stylus pen, touch screen, or the like. These and other input devices are often connected to the processing unit 504 through an input device interface 542 that is coupled to the system bus 508, but can be connected by other interfaces such as a parallel port, IEEE 1394 serial port, a game port, a USB port, an IR interface, etc.

A monitor 544 or other type of display device is also connected to the system bus 508 via an interface, such as a video adaptor 546. In addition to the monitor 544, a computer typically includes other peripheral output devices (not shown), such as speakers, printers, etc.

The computer 502 may operate in a networked environment using logical connections via wire and/or wireless communications to one or more remote computers, such as a remote computer(s) 548. The remote computer(s) 548 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wire/wireless connectivity to a local area network (LAN) 552 and/or larger networks, for example, a wide area network (WAN) 554. Such LAN and WAN networking environments are commonplace in offices and companies, and facilitate enterprise-wide computer networks, such as intranets, all of which may connect to a global communications network, for example, the Internet.

When used in a LAN networking environment, the computer 502 is connected to the LAN 552 through a wire and/or wireless communication network interface or adaptor 556. The adaptor 556 can facilitate wire and/or wireless communications to the LAN 552, which may also include a wireless access point disposed thereon for communicating with the wireless functionality of the adaptor 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wire and/or wireless device, is connected to the system bus 508 via the input device interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

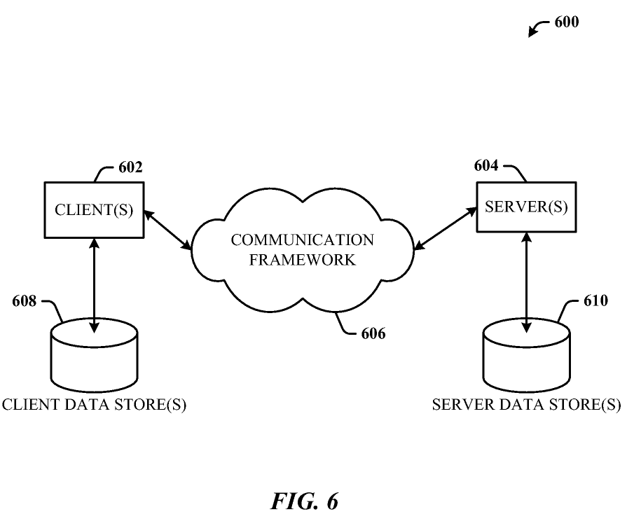

Referring now to FIG. 6, there is illustrated a schematic block diagram of an exemplary computing environment 600 for managing personal archives in a client-server environment. The environment 600 may include one or more client(s) 602. The client(s) 602 may be hardware and/or software (e.g., threads, processes, computing devices). The client(s) 602 may house a mail client application, cookie(s) and/or associated contextual information, for example.

The environment 600 may also include one or more server(s) 604. The server(s) 604 may also be hardware and/or software (e.g., threads, processes, computing devices). The servers 604 may house threads to perform transformations by employing the architecture, for example. One possible communication between a client 602 and a server 604 may be in the form of a data packet adapted to be transmitted between two or more computer processes. The data packet may include email data, a cookie and/or associated contextual information, for example. The environment 600 may include a communication framework 606 (e.g., a global communication network such as the Internet) that may be employed to facilitate communications between the client(s) 602 and the server(s) 604.

Communications can be facilitated via a wire (including optical fiber) and/or wireless technology. The client(s) 602 may be operatively connected to one or more client data store(s) 608 that may be employed to store information local to the client(s) 602 (e.g., cookie(s) and/or associated contextual information). Similarly, the server(s) 604 may be operatively connected to one or more server data store(s) 610 that can be employed to store information local to the servers 604. Server data stores 610 may also be employed to store mailbox data for a mail server application.

The client(s) 602 can include the client system 202, which may further include the mail client 106. The server(s) 604 can include the server system 204, which further includes the primary mailbox component 102 and the alternate mailbox component 104 (for the client-server embodiment).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system to manage data, comprising:
a primary mailbox component (102), associated with a user, and operative to receive and send electronic mail (email);
an alternate mailbox component (104) separate from the primary mailbox component and associated with the user and the primary mailbox, operative to store email; and
a mail client (106) operative on a client computer (202) to access and display contents of the primary and alternate mailboxes substantially simultaneously.

2. The system of claim 1, wherein the content of the alternate mailbox is stored remotely from the client computer.

3. The system of claim 1, wherein the content of the alternate mailbox is stored remotely from the content of the primary mailbox.

4. The system of claim 1, wherein the primary mailbox component comprises at least one of: an inbox folder (310), a sent items folder (314), a deleted items folder (306), or a search folder (316); and wherein the alternate mailbox component comprises at least one of: a deleted items folder (318) or a search folder (322).

5. The system of claim 4, wherein the alternate mailbox component is further operative to send an email from the alternate mailbox and to store a copy of the sent email in the sent items folder of the primary mailbox, and wherein the sent email appears to have been sent from the primary mailbox.

6. The system of claim 4, wherein the alternate mailbox component is further operative to move a content item to the deleted items folder of the alternate mailbox when the item is deleted from the alternate mailbox.

7. The system of claim 1, further comprising archiving policies (208) that, when applied, cause contents of the primary mailbox to be copied to, moved to, or deleted from the alternate mailbox automatically.

8. The system of claim 1, further comprising: a user component (210) that comprises a list of associated mailboxes of a user.

9. The system of claim 1, wherein the alternate mailbox component comprises at least one of: a unique identifier (108), a location (110), a display name (112), a mailbox address (114), a quota (116), or a flag (118).

10. The system of claim 1, wherein the alternate mailbox is created and associated with the primary mailbox remotely from the client computer, and wherein the mail client automatically discovers an alternate mailbox.

11. The system of claim 1, wherein the alternate mailbox is accessible to an administrator regardless of whether the associated user is logged in to the primary mailbox.

12. The system of claim 1, wherein an alternate mailbox may be disassociated with the user and associated with a new user.

13. The system of claim 1, wherein the mail client is operative to search the primary and alternate mailboxes in the same search operation.

14. A computer-implemented method of archiving data, comprising:
providing a primary email mailbox associated with a user;
providing an alternate email mailbox separate from the primary mailbox and associated with the user and the primary mailbox; and
providing access to the primary and alternate mailboxes via a mail client operating on a client computer.

15. The method of claim 14, further comprising:
storing the contents of the alternate mailbox remotely from the client computer.

16. The method of claim 14, further comprising:
storing the content of the alternate mailbox remotely from the content of the primary mailbox.

17. The method of claim 14, further comprising:
creating and associating the alternate mailbox with the primary mailbox remotely from the client computer, and
automatically discovering an alternate mailbox with the mail client.

18. The method of claim 14, wherein the primary and alternate mailboxes each comprise at least one subfolder, the method further comprising:
sending an email from the alternate mailbox; and
storing a copy of the sent email in a subfolder of the primary mailbox.

19. An article comprising a storage medium containing instructions that when executed enable a system to:
provide a primary email mailbox associated with a user;
provide an alternate email mailbox separate from the primary mailbox and associated with the user and the primary mailbox;
provide access to the primary and alternate mailboxes via a mail client operating on a client computer.

20. The article of claim 19, further containing instructions that when executed enable a system to store the contents of the alternate mailbox remotely from the client computer, or store the contents of the alternate mailbox remotely from the content of the primary mailbox.
